(19) United States
(12) Patent Application Publication
(10) Pub. No.: US 2026/0163221 A1
(43) Pub. Date: Jun. 11, 2026

(54) BATTERY CASE AND SECONDARY BATTERY INCLUDING THE BATTERY CASE

(71) Applicant: SAMSUNG SDI CO., LTD., Yongin-si (KR)

(72) Inventors: Eunseok OH, Yongin-si (KR); Seokyo JEOUNG, Yongin-si (KR); Hanbyeol JANG, Yongin-si (KR); Jaehyeon YUN, Yongin-si (KR)

(21) Appl. No.: 19/297,117

(22) Filed: Aug. 12, 2025

(30) Foreign Application Priority Data
Dec. 5, 2024 (KR) 10-2024-0179784

(51) Int. Cl. H01M 50/655; H01M 50/103; H01M 50/119; H01M 50/15; H01M 50/184; H01M 50/186; H01M 50/191; H01M 50/333

(52) U.S. Cl. CPC H01M 50/655; H01M 50/103; H01M 50/119; H01M 50/15; H01M 50/184; H01M 50/186; H01M 50/191; H01M 50/333

(57) ABSTRACT

A battery case includes a can including an injection port formed in a first surface structure and a second surface structure that is different from the first surface structure, with an opening being formed in the first surface structure. A cover seals the opening in the second surface structure of the can. A support structure is disposed outside the can, with a first surface of the support structure being on the first surface of the can. A first opening in the support structure is aligned with the injection port, and a second opening is formed in a second surface of the support structure that is different from the first surface of the support structure. A sealing member is positioned in the first opening to seal the first opening.

### CROSS-REFERENCE TO RELATED APPLICATION

The present application claims priority to Korean Patent Application No. 10-2024-0179784, filed on Dec. 5, 2024, the entire contents of which are incorporated herein for all purposes by this reference.

### BACKGROUND

### Field

The present disclosure relates to a battery case for accommodating an electrode assembly and a secondary battery including the battery case.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The battery case of a secondary battery has an injection port for discharging gas when activating the cell. During the process of partially injecting an electrolyte through the injection port and activating the cell, the injection port is open, which may cause the dispersion of the electrolyte. In addition, the electrolyte being injected into the cell and discharging the gas is a complicated part of process of manufacturing a secondary battery.

The above information disclosed in this Background section is for enhancement of understanding of the background of the present disclosure, and therefore, it may contain information that does not constitute related (or prior) art.

### SUMMARY

The present disclosure provides a battery case and a secondary battery including the battery case for solving the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a battery case may include a can a can comprising a first surface structure with an injection port formed there therein and a second surface structure with an opening formed therein, the second surface structure being different from the first surface structure; a cover sealing the opening in the second surface structure of the can; a support structure disposed outside the can, with a first surface structure of the support structure being on the first surface structure of the can, with a first opening in the support structure being aligned with the injection port, and with a second opening being formed in a second surface structure of the support structure that is different from the first surface of the support structure; and a sealing member in the first opening to seal the first opening.

The battery case may further include an opening-and-closing member interposed between the support structure and the sealing member and configured to control opening and closing of the first opening by the sealing member based on a pressure inside of the can and the cover.

In an embodiment, the opening-and-closing member may be in contact with the sealing member and may include an elastic member compressed in a direction away from the can.

In an embodiment, the elastic member may be a coil spring, with a first end of the coil spring connected to the support structure and with a second end of the coil spring connected to the sealing member.

In an embodiment, the elastic member may be a leaf spring, with a first end of the leaf spring connected to the support structure and with a second end of the leaf spring connected to the sealing member, and a bending point of the leaf spring may be in contact with a side surface structure of the support structure.

In an embodiment, the support structure may include a displacement limiting member located on the side surface structure of the support structure and configured to limit a maximum displacement of the bending point.

In an embodiment, the opening-and-closing member may be in contact with the sealing member and include a hinge member disposed on the support structure, and a rotational axis of the hinge member may be parallel to the first surface structure of the can.

In an embodiment, the sealing member may include a first body contacting an upper surface of the support structure and a second body as a remaining part of the sealing member, and at least one of the first body and the second body of the sealing member may include an elastic material that is compressible in a direction away from the can.

In an embodiment, the elastic material may include at least one of rubber, urethane, silicone and sponge with air voids.

In an embodiment, a Young's Modulus of the first body may be lower than a Young's Modulus of the second body.

In an embodiment, the can may include stainless steel.

In an embodiment, a depth of the injection port in the support structure may range from 10 μm to 200 μm.

In an embodiment, a material of the sealing member may include at least one of stainless steel and steel.

In an embodiment, a shape of the sealing member may be a cone or a pyramid.

In an embodiment, the support structure may include a protrusion inserted into the injection port, and a width of the protrusion may decrease in a direction toward an inside of the can.

According to one or more embodiments of the present disclosure, a secondary battery may include an electrode assembly including a first electrode, a second electrode, and a separator interposed between the first electrode and the second electrode, and a case configured to accommodate the electrode assembly, and the case includes a can a can comprising a first surface structure with an injection port formed there therein and a second surface structure with an opening formed therein, the second surface structure being different from the first surface structure; a cover sealing the opening in the second surface structure of the can; a support structure disposed outside the can, with a first surface structure of the support structure being on the first surface structure of the can, with a first opening in the support structure being aligned with the injection port, and with a second opening being formed in a second surface structure of the support structure that is different from the first surface of the support structure; and a sealing member in the first opening to seal the first opening

In an embodiment, the case may further include an opening-and-closing member interposed between the support structure and the sealing member and configured to control opening and closing of the first opening by the sealing member based on a pressure inside the can and cover.

In an embodiment, the opening-and-closing member may be in contact with the sealing member and include an elastic member that is compressible in a direction away from the can. The elastic member may be a coil spring or a leaf spring, with a first end of the coil spring or leaf spring being connected to the support structure and a second end of the coil spring or the leaf spring being connected to the sealing member.

In an embodiment, the opening-and-closing member may be in contact with a side surface structure of the sealing member and may include a hinge member that is disposed on the support structure.

In an embodiment, the sealing member may include a first body contacting an upper surface of the support structure and a second body which as a remaining part of the sealing member, and at least one of the first body and the second body of the sealing member may include an elastic material that is compressible in a direction away from the can.

The battery case according to embodiments of the present disclosure may include a sealing member partially inserted into the inside of an injection port, and an opening-and-closing member connected to the sealing member may be compressed away from the battery case as a result of the pressure inside the battery case. Accordingly, the opening and closing state of the injection port may be controlled by the pressure inside the battery case, and a problem of dispersing the electrolyte during the cell activation may be reduced or removed. Further a process of injecting additional electrolyte may be omitted.

The battery case according to exemplary embodiments may include a sealing member partially inserted into the inside of the injection port, and the sealing member may be compressed away from the battery case as a result of the pressure inside the battery case. Accordingly, the opening and closing state of the injection port may be controlled by the pressure inside the battery case, and a problem of dispersing the electrolyte during the cell activation may be reduced or removed. Further, a process of injecting additional electrolyte may be omitted.

According to embodiments, there is provided a secondary battery with a low likelihood of the electrolyte dispersion during the cell activation and additional electrolyte injection.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1A is a plan view of a battery case according to an embodiment of the present disclosure.

FIG. 1B is a side view of a battery case according an embodiment.

FIG. 1C is a perspective view of a support structure included in a battery case according to an embodiment.

FIG. 1D is a side view of a support structure included in a battery case according to an embodiment.

FIG. 1E is a side view of a support structure included in a battery case according to another embodiment.

FIG. 2A is a view of a part of a battery case according to an embodiment.

FIG. 2B is a conceptual view of a status when a battery case when discharging gas according to the embodiment of FIG. 2A.

FIG. 2C is a view of a battery case according to an embodiment.

FIG. 3A is a view of a part of a battery case according to an embodiment.

FIG. 3B is a conceptual view of a status when discharging case from a battery case according to the embodiment of FIG. 3A.

FIG. 4A is a view of a battery case according to an embodiment.

FIG. 4B is a conceptual view of a status when discharging gas from a battery case according to an exemplary embodiment of FIG. 4A.

FIG. 4C is a view of a part of a support structure included in a battery case according to the embodiment of FIG. 4A.

FIG. 5A is a view of a part of a battery case according to an embodiment.

FIG. 5B is a plan view of a support structure, a sealing member and an opening-and-closing member of a battery case according to an embodiment.

FIG. 5C is a conceptual view of a status when a battery case discharges gas according to the embodiment of FIG. 5A.

FIG. 5D is a perspective view of a support structure, a sealing member and an opening-and-closing member when a battery case discharges gas according to the embodiment of FIG. 5C.

FIG. 6A is a perspective view of a plane of a battery case according to an embodiment.

FIG. 6B is a view of a battery case according to an embodiment of FIG. 6A taken along line B-B′.

FIG. 6C is a perspective view of a plane of a secondary battery according to another embodiment.

FIG. 7 is a schematic view of a battery electric device according to embodiments of the present disclosure.

FIG. 8 is a view of a battery module arranged in a battery electric device according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used through this specification is for the purpose of describing embodiments of the present disclosure and is not intended to limit the present disclosure.

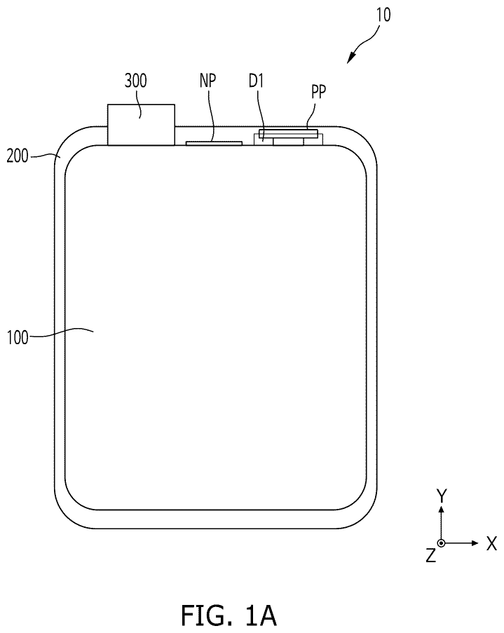

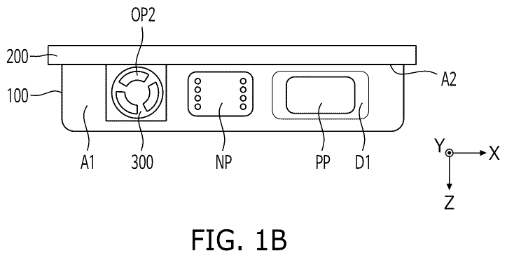

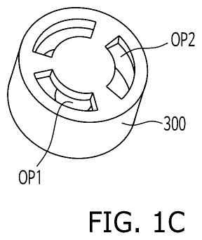

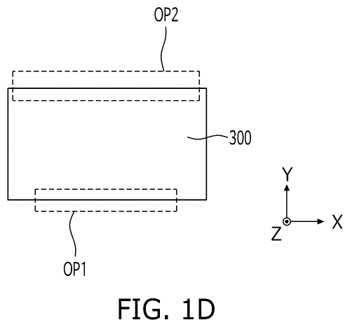

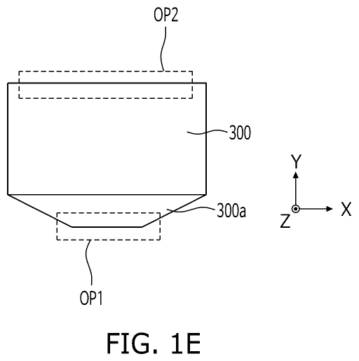

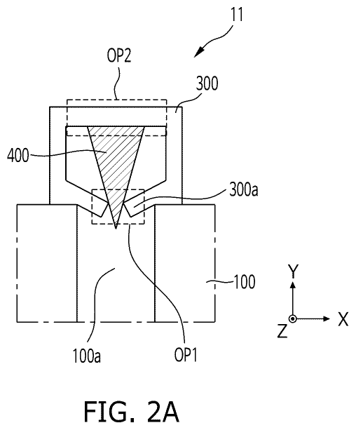

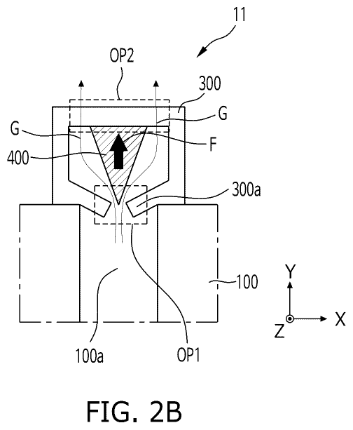

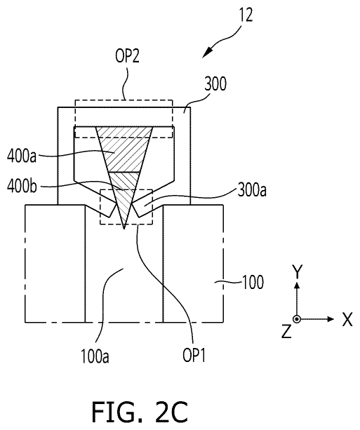

FIG. 1A is a plan view of a battery case according to an embodiment of the present disclosure. FIG. 1B is a side view of a battery case according an embodiment. FIG. 1C is a perspective view of a support structure included in a battery case according to an embodiment. FIG. 1D is a side view of a support structure included in a battery case according to an embodiment. FIG. 1E is a side view of a support structure included in a battery case according to another embodiment. FIG. 2A is a view of a part of a battery case according to an embodiment. FIG. 2B is a conceptual view of a status when a battery case discharges gas according to an embodiment of FIG. 2A discharges gas. FIG. 2C is a view of a part of a battery case according to an embodiment.

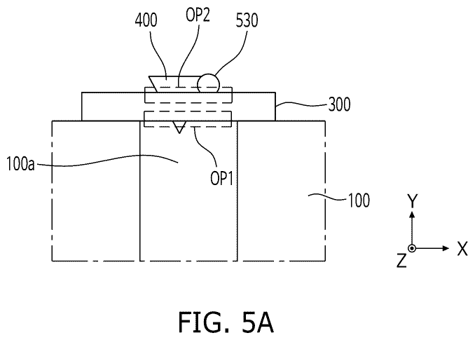

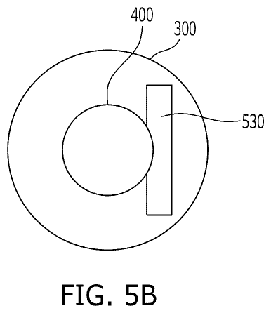

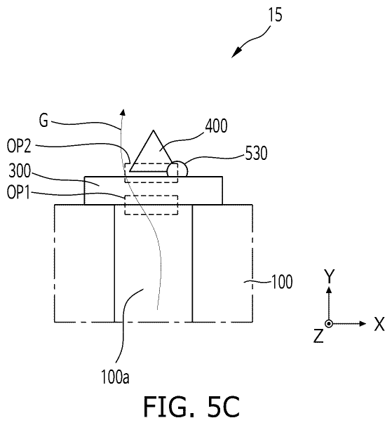

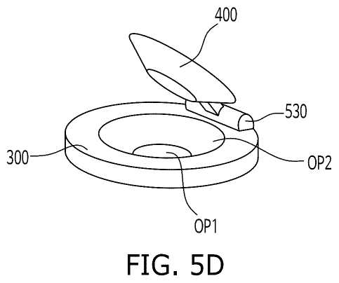

Referring to FIG. 1A to FIG. 1E, a battery case 10 according to an embodiment may include a can 100 with an injection port 100a in a first surface A1 and a second surface A2 different from the first surface A1, and a cover 200 for sealing the second surface A2 of the can 100. A support structure 300 is disposed on the first surface A1 outside the can 100 and includes a first opening OP1 aligned with an injection port (e.g., 100a of FIG. 2A) and a second opening OP2 in a surface different from the surface on which the first opening OP1 is placed. A sealing member (e.g., 400 of FIG. 2A) is inserted into the first opening OP1 for sealing the upper surface of the first opening OP1. The sealing member 400 may be disposed in direct contact with the upper surface of the support structure 300 or connection to the upper surface of the support structure 300 through opening-and-closing members 510, 520 and 530 (refer to FIG. 2A and FIG. 5D) interposed between the sealing member 400 and the support structure 300.

When the sealing member 400 is disposed in direct contact with the upper surface of the support structure 300, a portion of the sealing member 400 may include an elastic material that is compressed away from the can 100. With this configuration, when the pressure inside the sealed can 100 and cover 200 is greater than a predetermined pressure, at least a portion of the sealing member 400 may be compressed and thereby spaced apart from the injection port 100a and the first opening OP1. Accordingly, the injection port 100a and the first opening OP1 may be opened, and gas inside the case 10 may be discharged to outside of the battery case 10 through the injection port 100a.

According to another embodiment, the sealing member 400 may be connected to the upper surface of the support structure 300 through an opening-and-closing member 500. The opening-and-closing members 510 and 520 may be compressed away from the can 100, or the opening-and-closing member 530 may function as a rotational axis connected to the sealing member 400, and the sealing member 400 may be spaced apart from the injection port 100a and the first opening OP1. With such structures, when the pressure of the inside the sealed can 100 and cover 200 is greater than a predetermined pressure, the injection port 100a and the first opening OP1 may be opened, and gas inside the case 100 may be discharged to outside of the battery case 100 through the injection port 100a.

Referring to FIG. 1A and FIG. 1B, a battery case 10 according to an exemplary embodiment may include a can 100. The can 100 may include further surfaces other than the surface of the battery case 10 described above, and the cover 200 contacting the can 100 may be disposed on surface(s) of the battery case 100. The surface of the battery case 10 where the cover 200 is disposed may be the second surface A2, which forms an opening. The second surface A2 may be different from the first surface A1 where the injection port 100a is disposed. The can 100 may form a part of the entire exterior of the battery case 10, and an electrode assembly may be accommodated in the can 100.

According to embodiments, the can 100 may be formed from stainless steel (SUS). However, the can 100 is not limited thereto and may be formed from other metals such as aluminum, an aluminum alloy, or nickel-plated steel.

The thickness of the can 100 may range from approximately 0.01 mm to 0.3 mm. However, the present disclosure is not limited thereto, and the can 100 may have a thickness that is less than 0.01 mm or greater than 0.3 mm.

The injection port 100a may be disposed in the first surface A1 of the can 100. The injection port 100a may connect the inside sealed by the can 100 and the cover 200 to outside of the battery case 10. An electrolyte may be injected into the inside of the battery case 10 through the injection port 100a. And gas accumulated inside the battery case 10 may be discharged through the injection port 100a. The depth of the injection port 100a may be substantially the same as the thickness of the can 100.

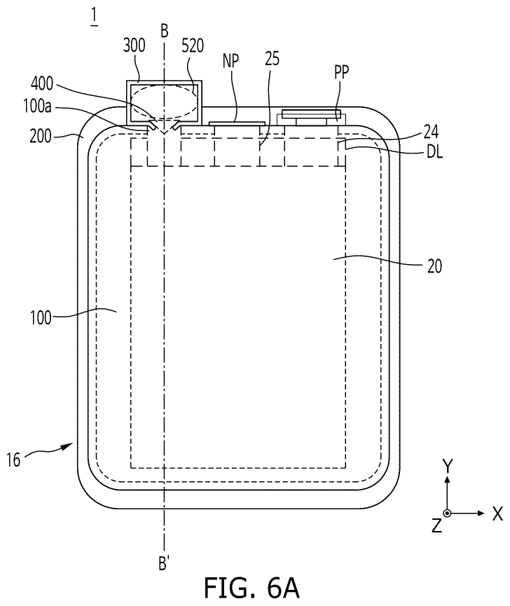

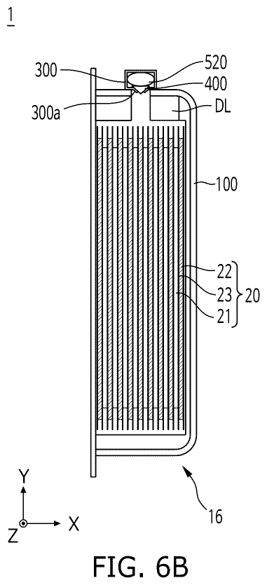

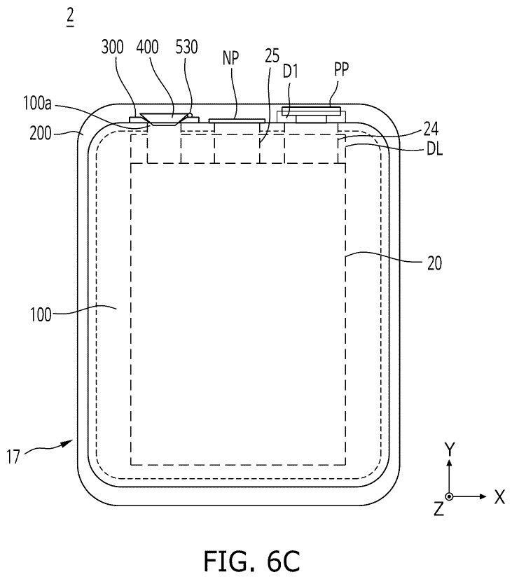

The can 100 may include a first terminal plate PP and a second terminal plate NP on the first surface A1. The first terminal plate PP may contact a first electrode tab of the electrode assembly to thereby be electrically connected to a first electrode (FIG. 6A). The second terminal plate NP may contact a second electrode tab of the electrode assembly to thereby be electrically connected to a second electrode (FIG. 6A). The can 100 may further include an insulator D1 that surrounds a portion of the first terminal plate PP. Accordingly, the first terminal plate PP may be spaced apart from the first surface A1 at a height so as to be on a plane different from the second terminal plate NP, which contacts the first surface A1. The first terminal plate PP and the second terminal plate NP each may be disposed on the first surface A1. However, the present disclosure is not limited thereto. In other embodiments, one of the first terminal plate PP or the second terminal plate NP may be disposed on a surface other than the first surface A1, and in still other embodiments both the first terminal plate PP and the second terminal plate N may be disposed on surfaces other than the first surface A1.

The second surface A2 of the can 100 have an opening formed therein to expose the inside of the can 100. Before the can 100 and the cover 200 of the battery case 10 are attached, an electrode assembly may be accommodated inside the can 100 through the opening formed in the second surface A2.

The battery case 10 according to an exemplary embodiment may include the cover 200, and the cover 200 may cover the opening formed in the second surface A2 of the can 100 to seal the inside of the can 100. A through hole formed in a surface other than the second surface A2 (for example, the injection port 100a) may be sealed by a different element. The width of the cover 200 may be equal to or greater than the width of the opened second surface A2 of the can 100. The cover 200 may be heat-sealed to the can 100. The can 100 and the cover 200 may be coupled to each other to form most of the exterior of the battery case 10. Thus, the inside of the battery case 10 may be sealed by the can 100 and the cover 200.

According to embodiments, the cover 200 may be formed from stainless steel (SUS). However, the cover 200 is not limited thereto. And the cover 200 may be formed from other metals such as aluminum, an aluminum alloy, or nickel-plated steel. In some examples, the cover 200 may include the same material as the can 100.

The thickness of the cover 200 may be from 0.01 mm to 0.3 mm. However, the present disclosure is not limited thereto. The cover 200 may have a thickness less than 0.01 mm or greater than 0.3 mm. In some example, the thickness of the cover 200 may be the same as that of the can 100.

Referring to FIG. 1A to FIG. 1E, the battery case 10 according to an exemplary embodiment may include a support structure 300. The support structure 300 may be disposed on the first surface A1 outside the can 100. The first opening OP1 included in the support structure 300 may be aligned with the injection port 100a, and the second opening OP2 included in the support structure 300 may be placed on a surface that is different from the surface where the first opening OP1 is formed. The support structure 300 may be bonded to the first surface A1 on the outside of the can 100. For example, the support structure 300 and the can 100 may be bonded to each other through heat fusion, and a method such as a welding may be used to bond the structures.

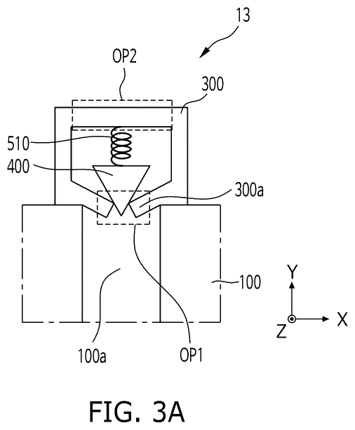

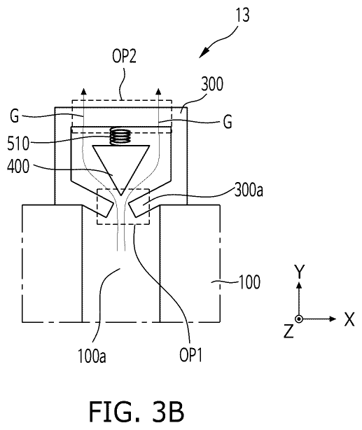

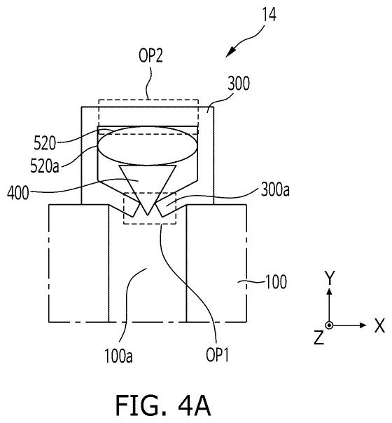

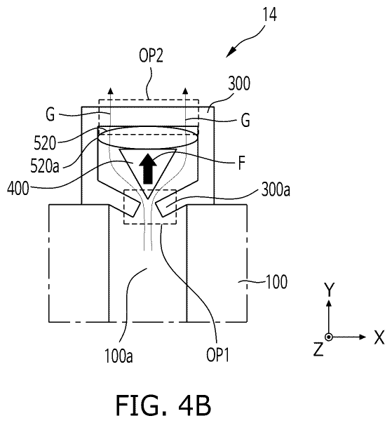

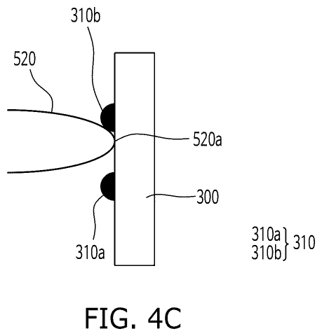

The support structure 300 may have a cavity formed therein to allow the sealing member 40o to be arranged inside the support structure 300. When the battery case 10 further includes opening-and-closing members 510 and 520 (FIG. 3A to FIG. 4B), the opening-and-closing members 510 and 520 may be arranged in the cavity in the support structure 300. However, the present disclosure is not limited thereto. In another embodiment, the sealing member 400 and/or an opening-and-closing member 530 (FIG. 5A to FIG. 5D) may be placed on the support structure 300.

The first opening OP1 of the support structure 300 may be aligned with the injection port 100a and arranged on the surface facing the injection port 100a. The area of the plane of the first opening OP1 may be less than or the same as the area of the plane of the injection port 100a. For example, the planar shape of the inlet of the first opening OP1 may be circular, and the three-dimensional shape of the injection port 100a may be cylindrical. The radius of the planar shape of the inlet of the first opening OP1 may be less than or equal to the radius of the bottom of the three-dimensional shape of the injection port 100a. However, the present disclosure is not limited to this configuration, and the area of the plane of the first opening OP1 may be greater than the area of the plane of the injection port 100a.

The first opening OP1 may be a passage through which gas from inside of the battery case 10 is discharged when the injection port 100a is opened. A portion of the sealing member 400 may be inserted into the inside of the first opening OP1 so that the first opening OP1 may be sealed. When the pressure inside the battery case 10 is equal to or greater than a predetermined value, the sealing member 400 may be spaced apart from the first opening OP1 so that the first opening OP1 may be opened to discharge the gas.

The second opening OP2 may a passage through which the gas inside the can 100 and the cover 200 is discharged through the injection port 100a and the first opening OP1 and discharged to outside of the battery case 10. The second opening OP2 may be formed in a different surface than the surface where the first opening OP1 is formed. For example, the second opening OP2 may be formed in the upper surface of the support structure 300. The upper surface of the support structure 300 may include one area contacting the sealing member 400 or the opening-and-closing member 500. The second opening OP2 may be formed in another area of the upper surfaces of the support structure 300. The area in which the second opening OP2 is formed may not overlap the area in contact with the sealing member 400 or the opening-and-closing member 500. The second opening OP2 may include at least one opening. In some examples, the second opening OP2 includes three openings positioned in a ring area on the upper surface of the support structure 300. The sealing member 400 and/or the opening-and-closing member 500 may be arranged below the ring area. However, the present disclosure is not limited to such a configuration, and the second opening OP2 may be disposed in various shapes and/or positions. For example, the second opening OP2 may have a plurality of circular openings, and the plurality of circular openings may be disposed on the upper surface and/or side surfaces of the support structure 300.

In the embodiment depicted in FIG. 1D, the outer circumference of the support structure 300 is a cylindrical and forms the first opening OP1 and the second opening OP2. The first opening OP1 and the second opening OP2 may formed on opposite sides of the cylinder. According to another embodiment, the second opening OP2 may be formed in the side surface of the cylinder. The gas discharged into the support structure 300 through the first opening OP1 may be discharged to outside of the support structure 300 (and outside of the battery case 10) through the second opening OP2. However, the outer circumference of the support structure 300 may be shapes other than cylindrical. That is, the support structure 300 may be a three-dimensional shape including the first opening OP1 connected to the sealed inside of the battery case 10 by exposing at least a part of the injection port 100a and the second opening OP2 connected to outside of the battery case 10.

In the embodiment depicted in FIG. 1E, the support structure 300 includes a protrusion 300a positioned in the injection port 100a. The inlet of the first opening OP1 may be formed in the protrusion 300a, and the inner surface of the protrusion 300a may be the circumference of the first opening OP1. For example, the protrusion 300a may have a width that decreases toward the inside of the can 100. The direction toward the inside of the can 100 may be, for example, a-Z direction. While at least a part of the protrusion 300a may be positioned inside of the injection port 100a, the present disclosure is not limited thereto. In other embodiments, the protrusion 300a may be disposed outside the injection port 100a.

Referring to FIG. 2A to FIG. 2C, the battery case 10 according to an embodiment may include the sealing member 400. The sealing member 400 may be positioned inside of the first opening OP1 and may seal the first opening OP1. For example, at least a part of the sealing member 400 may be positioned inside of the injection port 100a, and the sealing member 400 may directly contact the upper surface of the support structure 300.

In the embodiment depicted in FIGS. 2A and 2B, the sealing member 400 includes an elastic material. The elastic material included in the sealing member 400 may be materials such as rubber, urethane, silicone, or a sponge including air voids. The elastic material included in the sealing member 400 may be compressed in the direction away from the can 100 (e.g., in a Y direction) by the pressure in the battery case 10. For example, when the pressure in the battery case 10 is equal to or greater than a predetermined pressure, the sealing member 400 may receive a force F away from the can 100 and thereby be spaced from the first opening OP1 and the injection port 100a. Gas G in the inside the can 100 and the cover 200 may be discharged through the injection port 100a and the first opening OP1. The gas G that flows into the support structure 300 may be discharged to the outside of the battery case 10 through the second opening OP2. The elastic material included in the sealing member 400 may be selected based on the pressure that can be applied to the sealing 400 in the direction away from the can. After the gas G is discharged, the force F applied to the sealing member 400 may be reduced, and the sealing member 400 may seal the first opening OP1 by an elastic force.

As shown in FIG. 2C, the sealing member 400 may include a first body 400a and a second body 400b. A part of the sealing member 400 contacting the upper surface of the support structure 300 may be the first body 400a, and other parts of the sealing member 400 may be the second body 400b. The second body 400b of the sealing member 400 may be a part of the sealing member 400 that seals the first opening OP1. The elastic material included the first body 400a of the sealing member 400 may be materials such as rubber, urethane, silicone, or sponge with air voids. The elastic material included in the first body 400a may be compressible in the direction away from the can 100 (e.g., in the Y direction) by the pressure of the sealed inside of the battery case 10. For example, when the pressure of the sealed inside of the battery case 10 is equal to or greater than a predetermined pressure, the first body 400a may be spaced apart from the first opening OP1 by receiving the force F away from the can 100, and the gas G inside of the battery case 10 may be discharged through the first opening OP1. The elastic material included in the first body 400a may be selected based on the pressure that can applied to the sealing member 400 in the direction away from the can 100. When the gas G is discharged, the force F applied to the second body 400b may be reduced, and the first body 400a may seal the first opening OP1 by an elastic force.

The Young's Modulus of the first body 400a of the sealing member 400 may be less than the Young's Modulus of the second body 400b. For example, the second body 400b contacting the electrolyte may include SUS, steel, or other metals. In such a configuration, even though the first body 400a receives substantially the same force F as the second body 400b due to the pressure of the sealed inside of the battery case 10, the first body 400a may be contracted relatively more than the second body 400b. However, the present disclosure is not limited thereto, and the Young's Modulus of the first body 400a of the sealing member 400 may be greater than that of the second body 400b. The second body 400b may include an elastic material, and due to the pressure inside of the battery case 10, the second body 400b may be contracted relatively more than the first body 400a so that the sealing member 400 may be spaced apart from the first opening OP. And, thus, the gas G inside of the battery case 10 may be discharged through the first opening OP1.

The three dimensional shape of the sealing member 400 may be a cone or a pyramid. The vertex of the cone or pyramid may be arranged relatively close to the can 100, and the bottom of the cone or pyramid may be arranged relatively far from the can 100. For example, the planar shape of the bottom of the cone or pyramid shape may be greater than the smaller of the planar shape of the injection port 100a or the planar shape of the first opening OP1, and the two planar shapes may be similar to each other. However, the present disclosure is not limited to such an arrangement. In other example, the cone or pyramid may be a truncated solid shape that includes the vertex, such as a cone or a pyramid. The shape may include two bottom surfaces that circles or polygons of different sizes, and where the cross-section cut by a plane having a central axis in the y-direction is an isosceles trapezoid.

FIG. 3A is a view of a battery case according to an embodiment. FIG. 3B is a conceptual view of when a battery case according to an embodiment of FIG. 3A discharges gas. FIG. 4A is a view of a part of a battery case according to an embodiment. FIG. 4B is a conceptual view of when a battery case according to an embodiment of FIG. 4A discharges gas. FIG. 4C is a view of a part of a support structure included in a battery case according to an embodiment of FIG. 4A.

Referring to FIG. 3A and FIG. 4B, a battery case 10 according to an embodiment may include a sealing member 400 and opening-and-closing members 510 and 520. The sealing member 400 may be inserted into the first opening OP1 and may seal the first opening OP1. For example, at least a part of the sealing member 400 may be positioned in the injection port 100a. For example, the opening-and-closing members 510 and 520 may be interposed between the support structure 300 and the sealing member 400. The opening and closing of the first opening OP1 may be controlled as the sealing member 400 due to the pressure inside of the battery case 100.

The sealing member 400 may include SUS, steel, or other metals. The three-dimensional shape of the sealing member 400 may be a cone or a pyramid. But the present disclosure is not limited to this shape, and be other shapes capable of sealing the first opening OP1.

The opening-and-closing members 510 and 520 may contact a surface of the sealing member 400. The opening-and-closing members 510 and 520 may include an elastic member compressible in the direction away from the can 100 (e.g., in the Y direction). In particular, the opening-and-closing members 510 and 520 may be compressed away from the can 100 by the pressure inside the battery case 10.

In the embodiment depicted in FIG. 3A and FIG. 3B, the elastic member of the opening-and-closing member 510 may be a coil spring with its ends connected to the support structure 300 and the sealing member 400. For example, the opening-and-closing member 510 as a coil spring may be interposed between the support structure 300 and the sealing member 400 in a state so that the sealing member 400 may be in contact with the first opening OP1. The elastic constant of the coil spring may be selected based on the pressure applied to the sealing member 400 in the direction away from the can 100. When the pressure inside of the battery case 10 is equal to or greater than a predetermined pressure, the opening-and-closing member coil spring 510 may be compressed by the sealing member 400, and the first opening OP1 may be opened. When the gas G is discharged, the force applied to the opening-and-closing member 510 may be reduced, and the sealing member 400 may seal the first opening OP1 by an elastic force from the coil spring.

In the embodiment depicted in FIG. 4A to FIG. 4C, the elastic member of the opening-and-closing member is a leaf spring with ends connected to the support structure 300 and the sealing member 40. The leaf spring may have a plate shape and elasticity. A bending point 520a disposed near the center of the leaf string may contact the side surface of the support structure 300. The opening-and-closing member leaf spring 520 may be interposed between the support structure 300 and the sealing member 400 in a compressed or bend state so that the sealing member 400 may be in contact with the first opening OP1. The elastic constant of the leaf spring may be selected based on the pressure applied to the sealing member 400 in the direction away from the can 100. When the pressure of inside of the battery case 10 is equal to or greater than a predetermined pressure, the opening-and-closing member leaf spring 520 may be compressed by the sealing member 400 so that the first opening OP1 is opened. As the length of the leaf spring in the y direction becomes smaller, the bent point 520a of the leaf spring may move in the y direction. After the gas G is discharged, the force F applied to the opening-and-closing member 520 may be reduced, and the sealing member 400 may seal the first opening OP1 by an elastic force of the leaf spring. As the length of the leaf spring in the y direction returns to its equilibrium length, the bending point 520a of the leaf spring may move in the opposite direction.

FIG. 4C shows the process where the opening-and-closing member 520 including the leaf spring is compressed or bent in the y direction due to the pressure inside the case 10 sealed by the can 100 and the cover 200. The support structure 300 of the battery case 10 according to an exemplary embodiment may include a displacement limiting member 310 that limits the maximum displacement of the bending point 520a on its side surface. For example, when the pressure of the sealed inside of the battery case 10 is less than a predetermined pressure, or the leaf spring is in equilibrium, the bending point 520a of the opening-and-closing member 520 may contact a first displacement limiting member 310a disposed relatively close to the can 100, or may be interposed between displacement limiting members 310a and 310b. When the pressure of the sealed inside of the battery case 10 is greater than a predetermined pressure, the bending point 520a of the opening-and-closing member 520 may contact a second displacement liming member 310b disposed further from the can 100. The bending point 520a contacting the second displacement limiting member 310b may not be more compressed or bent even through a greater force F is applied. The second displacement limiting member 310b may prevent the opening-and-closing member 520 from being excessively compressed or bent. The displacement limiting member 310 may ensure the stability of the opening-and-closing member 520. For example, even under the excessive force F, the opening-and-closing member 520 may resist further compression or bending, thereby preventing the opening-and-closing member 520 from being displaced from its position, breaking, or losing its elasticity.

As described above, a displacement limiting member may include a first displacement limiting member 310a and a second displacement limiting member 310b that are at different distances from the can 100. But the present disclosure is not limited to a configuration with two displacement members and may include a single displacement limiting member 310. The second displacement limiting member 310b may be positioned farther from the can 100 than the bending point 520a of the opening-and-closing member 520 to thereby prevent the opening-and-closing member 520 from being excessively compressed or bent.

According to the embodiments depicted in FIG. 1A to FIG. 4D, battery cases 10, 11, 12, 13 and 14 may be compressed by internal pressure in the direction where the closing members 400 and 420 and/or the opening-and-closing members 510 and 520 are away from the can 100. Accordingly, when gas G accumulates in the battery cases 10, 11, 12, 13 and 14, the sealing members 400 and 420 that seal the injection port 100a and the first opening OP1 may be spaced apart from the first opening OP1 due to the force F away from the can 100 such that the gas G may be discharged to the outside of the battery cases 10, 11, 12, 13 and 14. When the gas G is sufficiently discharged, the sealing members 400 and 420 an/or the opening-and-closing members 510 and 520 may reseal the injection port 100a and the first opening OP1 by the elastic force in a direction towards the can. As the gas G is discharged according to the pressure inside the battery cases 10, 11, 12, 13 and 14, during the cell activation of a secondary battery with one of the battery cases 10, 11, 12, 13 and 14, the dispersing of the injected electrolyte may be alleviated. In addition, multiple injection the electrolyte may not be needed, thereby prevent the defects arising during the process.

FIG. 5A is a view of a battery case according to an embodiment. FIG. 5B is a plan view of a support structure, a sealing member and an opening-and-closing member of a battery case according to an embodiment. FIG. 5C is a conceptual view of when a battery case discharges gas according to an the embodiment of FIG. 5A. FIG. 5D is a perspective view of a support structure, a sealing member, and an opening-and-closing member when a battery case discharges gas according to the embodiment of FIG. 5C.

Referring to FIG. 5A to FIG. 5D, a battery case 15 may include a sealing member 400 and an opening-and-closing member 530. The sealing member 400 may be inserted into the first opening OP1 and may seal the first opening OP1. In addition, the sealing member 400 may be inserted into the second opening OP2 and may seal the second opening OP2. The first opening OP1 may be formed on the lower surface of the support structure 300, and the second opening OP2 may be formed on the upper surface of the support structure 300. The first opening OP1 may be connected to the second opening OP2. The sealing member 400 may be inserted into the first opening OP1 and the second opening OP2 of the support structure 300 along the thickness direction of the support structure 300 approaching the can 100, and the sealing member 400 may thereby seal the first opening OP1 and the second opening OP2. The opening-and-closing member 530 may be placed on the support structure 300 while in contact with the sealing ember 400. The opening and closing of the first opening OP1 and the second opening OP2 may be controlled by the pressure inside of the battery case 15 including the can 100 and the cover 200.

The sealing member 400 may be formed from SUS, steel, or other metals. The three-dimensional shape of the sealing member 400 may be a cone or a pyramid. The vertex of the cone or pyramid may be positioned closer to the can 100, and the bottom of the cone or pyramid may be positioned relatively far from the can 100. The area of the cross-section of the inlet of the first opening OP1 may be less than the area of the cross-section of the inlet of the second opening OP2. The cross-sections may be perpendicular to the y direction. However, the present is not limited to such a configuration, and the sealing member 400 may have other shapes that seal the first opening OP1 and the second opening OP2.

The opening-and-closing member 530 may include a hinge member. The opening-and-closing member 530 including the hinge member may be disposed on the support structure 300. For example, the opening-and-closing member 530 may be disposed on the surface including the second opening OP2 of the support structure 300. The opening-and-closing member 530 including the hinge member may contact a surface of the sealing member 400. For example, the opening-and-closing member 530 may contact a side surface of the sealing member 400. However, the present disclosure is not limited to such an arrangement, and the opening-and-closing member 530 including the hinge member may contact the upper surface of the sealing member 400. The opening-and-closing member 530 also may have a different connection structure that allows the sealing member 400 to be deviated from the first opening OP1 and/or the second opening OP2. The rotational axis of the hinge member may be parallel to the first surface A1 of the can 100. For example, the rotational axis of the hinge member may be in the z direction as depicted. The hinge member may connect the support structure 300 and the sealing member 400 so that the sealing member 400 may not be deviated from the battery case 10 when the sealing member 400 moves or rotates in the direction away from the can 100. The sealing member 400 may rotate with respect to the rotational axis, and the distance between the sealing member 400 and the opening-and-closing member 530 may be maintained.

The opening-and-closing member 530 including the hinger member may include a spring. When the pressure inside of the battery case 15 is equal to or less than a predetermined pressure, the sealing member 400 may move to seal the first opening OP1 and the second opening OP2 by an elastic force included in the hinge member. When the pressure of the sealed inside of the battery case 15 is greater than a predetermined pressure, the spring of the opening-and-closing member 530 may be compressed, the sealing member 400 may be deviated from the first opening OP1 and the second opening OP2, and the gas G inside of the battery case 15 may be discharged. The elastic constant of the spring may be selected based on the pressure applied to the sealing member 400 in the direction away from the can 100. After the gas G is discharged, a torque applied to the sealing member 400 may be reduced, and the sealing member 400 may seal the first opening OP1 and/or the second opening OP2.

In the battery case 15 depicted in FIG. 5A to FIG. 5D, the opening-and-closing member 530 that moves according to the internal pressure may include a hinge member, and the sealing member 400 may move or rotate in the direction away from the can 100. And the hinge member may include a compressible spring. Accordingly, when the gas G accumulates in the sealed inside of the battery case 15, the sealing member 400 that seals the injection port 100a, the first opening OP1 and/or the second opening OP2 may be spaced apart from the injection port 100a, the first opening OP1 and/or the second opening OP2. As the first opening OP1 and/or the second opening OP2 is opened, the gas G may be discharged to outside of the battery case 15. When the gas G is sufficiently discharged, the sealing member 400 may move to seal the first opening OP1 and/or the second opening OP2 by an elastic force included in the opening-and-closing member 530. When the gas G according to the pressure of the sealed inside of the battery case 15 is discharged, and the cell of the secondary battery including the battery case 15 is activated, and the dispersing of the electrolyte may be reduced. In addition, their may not be necessary to inject electrolyte multiple times, thereby providing a secondary battery with less defects.

FIG. 6A is a perspective view of a plane of a battery case according to an embodiment. FIG. 6B is a view of a battery case of FIG. 6A taken along line B-B′. FIG. 6C is a perspective view of a plane of a secondary battery according to another embodiment.

Referring to FIG. 6A and FIG. 6B, a secondary battery 1 may include an electrode assembly 20 including a first electrode 21 and a second electrode 22a and a separator interposed between the first electrode 21 and the second electrode 22, and a case 16 that accommodates the electrode assembly 20. The case 16 may include a cover 200 that seals the can 100 and an injection port 100a. The secondary battery 1 may also include a support structure 300 including the first opening OP1 aligned with the injection port 100a and the second opening OP2 disposed on a surface different from the surface where the first opening OP1 is placed. A sealing member 400 is inserted into the first opening OP1 to seal the upper surface of the first opening OP1.

The sealing member 400 may be connected to the upper surface of the support structure 300 by the opening-and-closing member 520 disposed between the sealing member 400 and the support structure 300. The case 16 may control the opening and closing of the first opening OP1 through the sealing member 400 due to the pressure inside of the case 16.

The electrode assembly 20 of the secondary battery 1 may include a first electrode 21, a second electrode 22, and a separator 23. The electrode assembly 20 may also include a first electrode tab 24 and a second electrode tab 25. The separator 23 may be interposed between the first electrode 21 and the second electrode 22 so that the first electrode 21 and the second electrode 22 are spaced apart and insulated from each other. The separator 23 may include an insulating material. The first electrode tab 24 may be connected to the first electrode 21, and the second electrode tab 25 may be connected to the second electrode 22. The electrode assembly 20 may be formed by winding the first electrode 21, the second electrode 22, and the separator 23. In another embodiment, the first electrode 21, the second electrode 22, and the separator 23 may be stacked to form the electrode assembly 20.

The first electrode 21 may include a substrate and an active material layer disposed on the substrate. An area where the active material layer is not provided on the substrate may be an uncoated part, and an area where the active material is disposed may be a composite part. A portion of the uncoated part may contact a first electrode tab 24, with the first electrode 21 and the first electrode tab 24 thereby being electrically connected to each other.

The second electrode 22 may include a substrate and an active material layer disposed on the substrate. An area where the active material layer is not provided on the substrate may be an uncoated part, and an area where the active material layer is disposed on the substrate may be a composite part. A portion of the uncoated part of the second electrode 22 may contact a second electrode tab 25, with the second electrode 22 and the second electrode tab 25 thereby being electrically connected to each other.

The first electrode tab 24 may contact a first terminal plate PP to be electrically connected to the first terminal plate PP. The second electrode tab 25 may contact a second terminal plate NP to be electrically connected to the second terminal plate NP.

The first electrode 21 may be one of a positive electrode or a negative electrode, and the second electrode 22 may be the other of a positive electrode or a negative electrode. That is, the first electrode 21 and the second electrode 22 may have opposite polarities. For example, when the first electrode 21 is a positive electrode, the second electrode 22 may be a negative electrode. In such a configuration, the active material layer included in the first electrode 21 may be a positive electrode active material layer, and the active material layer included in the second electrode 22 may be a negative electrode active material layer. The positive electrode active material layer may include a transition metal oxide, and the negative electrode active material layer may include graphite. According to the above-described example, the substrate of the first electrode 21 may include, for example, aluminum (Al) foil, and the substrate of the second electrode 22 may include, for example, copper (Cu) or nickel (Ni) foil. However, the present disclosure is not limited to these examples, and various other materials suitable for the polarity of a substrate or an active material layer may be used.

The separator 23 may allow the movement of specific ions and electrically insulate the first electrode 21 from the second electrode 22. as such, the separator 23 may prevent the short-circuit of the first electrode 21 and the second electrode 22. The separator 23 may include, for example a polyethylene film, a polypropylene film, a polyethylene-polypropylene film, etc., but the present disclosure is not limited to these examples.

The first electrode tab 24 may be electrically connected to the first electrode 21, and may electrically connect the first electrode 21 to the first terminal plate PP. The second electrode tab 25 may be electrically connected to the second electrode 22, and may electrically connect the second electrode 22 to the lower terminal plate NP.

The opening-and-closing member 520 included in the case battery 1 may include an elastic material compressible in the direction away from the can 100 (e.g., y direction). The sealing member 400 may be connected to the upper surface of the support structure 300 by the opening-and-closing member 520, and compressed in the direction away from the can 100. In particular, the opening-and-closing member 520 may be compressed in the direction away from the can 100 by the pressure inside of the case 16.

When the pressure inside of the case 16 is greater than a predetermined pressure, the opening-and-closing member 520 may be compressed and gas may be discharged from the case 16.

Referring to FIG. 6A and FIG. 6B, the opening-and-closing member 520 may include a leaf spring, which is an elastic member. In other embodiments, the elastic member may be a coil spring. The present disclosure is not limited with respect the arrangement. For example, in further embodiments, the sealing member 400 directly contacts the support structure 300 instead of the opening-and-closing member 520, and the sealing member 400 includes an elastic material.

The case 16 included in the battery case 1 according to an exemplary embodiment may correspond to the battery cases 10, 11, 12, 13 and 14, as described above.

Referring to FIG. 6C, the sealing member 400 included in the secondary battery 2 may be inserted into the first opening OP1 and thereby seal the first opening OP1. The sealing member 400 may also be inserted into the second opening OP2 and thereby seal the second opening OP2. The first opening OP1 may be formed in the lower surface of the support structure 300, and the second opening OP2 may be formed in the upper surface of the support structure 300. The first opening OP1 and the second opening OP2 may be connected to each other. The opening-and-closing member 530 may be disposed on the support structure 300 which is in contact with the sealing member 400. The opening and closing of the first opening OP1 and/or the second opening OP2 by the sealing member 400 according may be controlled by the pressure inside of the case 17.

The opening-and-closing member 530 included in the secondary battery 2 may include a hinge member. The opening-and-closing member 530 including a hinge member may be disposed on the support structure 300. In one example, the opening-and-closing member 530 may be disposed on a surface of the support structure that includes the second opening OP2. The opening-and-closing member 530 may contact a side surface of the sealing member 400. The rotational axis of the hinge member may be parallel to the first surface A1 (FIG. 1B). When the sealing member 400 moves or rotates in the direction away from the can 100, the hinge member may connect the support structure 300 to the sealing member 400 so that the sealing member 400 may not separate from the case 17. In particular, the sealing member 400 may rotate with respect to the rotational axis, and the distance between the sealing member 400 and the opening-and-closing member 530 may be maintained.

The opening-and-closing member 530 including a hinge member may include a spring. When the pressure of the sealed inside of the case 17 is equal to or less than a predetermined pressure, the sealing member 400 may seal the first opening OP1 and the second opening OP2 by an elastic force of the spring included in the opening-and-closing member 530. When the pressure of the sealed inside of the case 17 is greater than a predetermined pressure, the spring of the opening-and-closing member 530 may be compressed, and the sealing member 400 may be opened so that the gas inside the case 17 may be discharged.

The case 17 included in the secondary battery 2 to the battery case 15 described above.

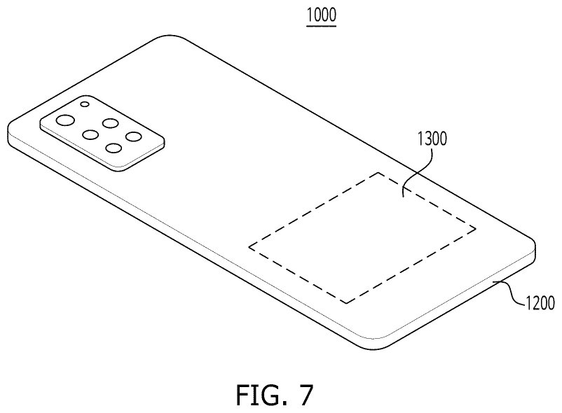

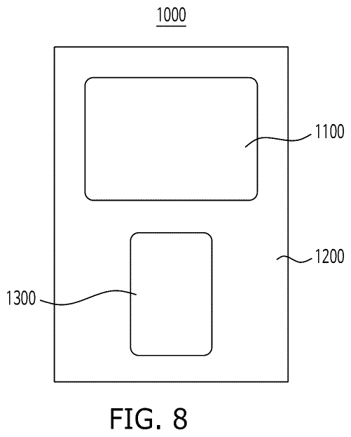

FIG. 7 is a schematic view of a battery electric device according to embodiments of the present disclosure. FIG. 8 is a view of a battery module arranged in a battery electric device according to embodiments of the present disclosure.

Referring to FIG. 7 and FIG. 8, a battery electric device 1000 according to embodiments of the present disclosure may include an operation unit 1100 that performs a set operation, a housing 1200 that accumulates the operation unit 1100, and a battery module 1300 fixed into the inside of the housing 1200 and supplying a power to the operation unit 1100.

The battery electric device 1000 including a power unit may be a smartphone. But the present disclosure is not limited to such a device, but present disclosure may applied to various other devices that use electric energy stored in the battery module 1300 and require a protection circuit.

The operation unit 1100 may include various hardware that is driven by receiving electric energy from the battery module 1300. For example, the operation unit 100 may include an application processor (AP), a central processing unit (CPU), etc. of a portable electronic device.

A printed circuit substrate (not shown) that includes a signal transmission wire may be placed inside the housing 1200, and the operation unit 1100 may be mounted on the printed circuit substrate and electrically connected to other elements of the battery electric device 1000.

The housing 1200 may accommodate the operation unit 1100 and the battery module 1300, and the housing 1200 may define the exterior of the battery electric device 1000. The housing 1200 may be provided as various structures as long as the operation unit 1100 and the battery module 1300 placed therein are supported and protected from an external force.

The battery module 1300 may be fixed into the inside of the housing 1200 to stably supply the power to the operation unit 1100. For example, the battery module 1300 may be formed by a chargeable and dischargeable secondary battery. The battery module 1300 may have substantially the same configuration as the secondary battery including the battery cases 10, 11, 12, 13, 14 and 15 described with reference to FIG. 1A to FIG. 5D, or the battery module including the secondary batteries 1 and 2 described with reference to FIG. 6A to FIG. 6C.

Although the present disclosure has been described above with respect to embodiments thereof, the present disclosure is not limited thereto. Various modifications and variations may be made thereto by those skilled in the art within the spirit of the present disclosure.

Description of Notations

| | |
|---|---|
| 1, 2: Secondary Battery | |
| 10: Battery Case | 20: Electrode Assembly |
| 100: Can | 100a: Injection Port |
| 200: Cover | 300: Support Structure |
| 400: Sealing Member | 510, 520, 530: Opening-and-closing |
| | member |
| OP1: First Opening | OP2: Second Opening |

What is claimed is:

1. A battery case comprising:
a can comprising a first surface structure with an injection port formed there therein and a second surface structure with an opening formed therein, the second surface structure being different from the first surface structure;
a cover sealing the opening in the second surface structure of the can;
a support structure disposed outside the can, with a first surface structure of the support structure being on the first surface structure of the can, with a first opening in the support structure being aligned with the injection port, and with a second opening being formed in a second surface structure of the support structure that is different from the first surface of the support structure; and
a sealing member in the first opening to seal the first opening.

2. The battery case as claimed in claim 1, further comprising an opening-and-closing member interposed between the support structure and the sealing member, the opening-and-closing member being configured to control opening and closing of the first opening by the sealing member based on a pressure inside of the can and the cover.

3. The battery case as claimed in claim 2, wherein the opening-and-closing member is in contact with the sealing member and comprises an elastic member configured to be compressed in a direction away from the can.

4. The battery case as claimed in claim 3, wherein the elastic member is a coil spring, with a first end of the coil spring connected to the support structure and with a second end of the coil spring connected to the sealing member.

5. The battery case as claimed in claim 3, wherein the elastic member is a leaf spring, with a first end of the leaf spring connected to the support structure and with a second end of the leaf spring connected to the sealing member, and
wherein a bending point of the leaf spring is in contact with a side surface structure of the support structure.

6. The battery case as claimed in claim 5, wherein the support structure comprises a displacement limiting member located on the side surface structure of the support structure, the displacement limiting member being configured to limit a maximum displacement of the bending point.

7. The battery case as claimed in claim 2, wherein the opening-and-closing member is in contact with the sealing member and comprises a hinge member disposed on the support structure, and
wherein a rotational axis of the hinge member is parallel to the first surface structure of the can.

8. The battery case as claimed in claim 1, wherein the sealing member comprises a first body contacting an upper surface of the support structure and a second body as a remaining part of the sealing member, and
wherein at least one of the first body and the second body of the sealing member comprises an elastic material configured to be compressed in a direction away from the can.

9. The battery case as claimed in claim 8, wherein the elastic material comprises at least one of rubber, urethane, silicone and sponge with air voids.

10. The battery case as claimed in claim 8, wherein a Young's Modulus of the first body is lower than a Young's Modulus of the second body.

11. The battery case as claimed in claim 1, wherein the can comprises stainless steel.

12. The battery case as claimed in claim 11, wherein a depth of the injection port in the support structure ranges from 10 μm to 200 μm.

13. The battery case as claimed in claim 1, wherein a material of the sealing member comprises at least one of stainless steel and steel.

14. The battery case as claimed in claim 1, wherein a shape of the sealing member is a cone or a pyramid.

15. The battery case as claimed in claim 1, wherein the support structure comprises a protrusion configured to be inserted into the injection port, and
wherein a width of the protrusion decreases in a direction toward an inside of the can.

16. A secondary battery, comprising:
an electrode assembly comprising a first electrode, a second electrode, and a separator interposed between the first electrode and the second electrode; and
a case configured to accommodate the electrode assembly,
wherein the case comprises:
a can comprising a first surface structure with an injection port formed therein and a second surface structure with an opening formed therein, the second surface structure being different from the first surface structure;
a cover sealing the opening in the second surface structure of the can;
a support structure disposed outside the can, with a first surface structure of the support structure being on the first surface structure of the can, with a first opening in the support structure being aligned with the injection port, and with a second opening being formed in a second surface structure of the support structure that is different from the first surface structure of the support structure; and
a sealing member in the first opening to seal the first opening.

17. The secondary battery as claimed in claim 16, wherein the case further comprises an opening-and-closing member interposed between the support structure and the sealing member, the opening-and-closing member being configured to control opening and closing of the first opening by the sealing member based on a pressure inside of the can and cover.

18. The secondary battery as claimed in claim 17, wherein the opening-and-closing member is in contact with the sealing member and comprises an elastic member configured to be compressed in a direction away from the can,
wherein the elastic member is a coil spring or a leaf spring, with a first end of the coil spring or leaf spring connected to the support structure and with a second end of the coil spring connected to the sealing member.

19. The secondary battery as claimed in claim 17, wherein the opening-and-closing member is in contact with a side surface structure of the sealing member and comprises a hinge member that is disposed on the support structure.

20. The secondary battery as claimed in claim 16, wherein the sealing member comprises a first body contacting an upper surface of the support structure and a second body as a remaining part of the sealing member, and
wherein at least one of the first body and the second body of the sealing member comprises an elastic material configured to be compressed in a direction away from the can.
